(19) United States
(12) Patent Application Publication
(10) Pub. No.: US 2026/0356201 A1
(43) Pub. Date: Nov. 12, 2026

(54) SYSTEM AND METHOD FOR PROVIDING RUNTIME ESTIMATE OF AUXILIARY DEVICES POWERED BY MOTOR VEHICLE

(71) Applicant: Ford Global Technologies, LLC, Dearborn, MI (US)

(72) Inventors: Shannon Wrobel, Ann Arbor, MI (US); Alexander Avila, Birmingham, MI (US); Andrew Erich Mast, Northville, MI (US)

(21) Appl. No.: 19/202,035

(22) Filed: May 8, 2025

(51) Int. Cl. B60L 1/00; B60L 58/12

(52) U.S. Cl. CPC B60L 1/00; B60L 58/12

(57) ABSTRACT

A motor vehicle may include a power source and a user interface configured to display an estimated time that the power source is able to supply power to an auxiliary device. A controller may generate the estimated time based on a type, make, or model of the auxiliary device that a user selects or enters via the user interface, and may cause the user interface to display the estimated time. The estimated time may further be based on a power capacity of the power source, such as a fuel level or a state of charge of a traction battery pack.

### TECHNICAL FIELD

This disclosure relates generally to motor vehicles, and more particularly to vehicle systems and methods for estimating the runtime of one or more auxiliary devices that are powered by the motor vehicle.

### BACKGROUND

Some motor vehicles include electrical power outlets that can be used to power auxiliary devices or loads separate from the vehicle. The electrical power outlets can be particularly useful for commercial vehicles and work trucks that are often at job sites and other areas that may lack an available grid power source. When at such sites, a user can power tools and other auxiliary devices through the electrical power outlets of the vehicle.

### SUMMARY

In some aspects, the techniques described herein relate to a motor vehicle, including: a power source; and a user interface configured to display an estimated time that the power source is able to supply power to an auxiliary device.

In some aspects, the techniques described herein relate to a motor vehicle, further including: a controller configured to generate the estimated time based on an input providing information about the auxiliary device, and wherein the controller is further configured to cause the user interface to display the estimated time.

In some aspects, the techniques described herein relate to a motor vehicle, wherein, after the controller first causes the user interface to the display the estimated time, the controller is configured to cause the user interface to display an updated estimated time that the power source is able to supply power to the auxiliary device.

In some aspects, the techniques described herein relate to a motor vehicle, wherein the controller generates the estimated time based on historical information associated with the auxiliary device.

In some aspects, the techniques described herein relate to a motor vehicle, wherein the controller generates the estimated time based on a power capacity of the power source.

In some aspects, the techniques described herein relate to a motor vehicle, wherein the power source includes a traction battery pack, and the power capacity is a state of charge of the traction battery pack.

In some aspects, the techniques described herein relate to a motor vehicle, wherein the power source includes an internal combustion engine, and the power capacity is a fuel level.

In some aspects, the techniques described herein relate to a motor vehicle, wherein the controller generates the estimated time based on a range reserve setting.

In some aspects, the techniques described herein relate to a motor vehicle, wherein the information is discerned from a machine-readable code associated with the auxiliary device.

In some aspects, the techniques described herein relate to a motor vehicle, wherein the machine-readable code is one of a QR code or a barcode.

In some aspects, the techniques described herein relate to a motor vehicle, wherein the information about the auxiliary device includes one or both of a power consumption rating of the auxiliary device and a type of the auxiliary device.

In some aspects, the techniques described herein relate to a motor vehicle, wherein: the user interface is provided by an infotainment system of the motor vehicle, and the information about the auxiliary device is discerned based on one or both of a selection made via the user interface and data entered into the user interface.

In some aspects, the techniques described herein relate to a motor vehicle, wherein: the user interface is provided by a mobile device, and the information about the auxiliary device is obtained using a camera of the mobile device.

In some aspects, the techniques described herein relate to a motor vehicle, further including: an electrical outlet configured to receive a plug of the auxiliary device and to direct power from the power source to the auxiliary device, wherein the motor vehicle is a pickup truck, and wherein the electrical outlet is arranged adjacent a cargo area of the pickup truck.

In some aspects, the techniques described herein relate to a motor vehicle, wherein the auxiliary device is one of a plurality of auxiliary devices, and wherein the user interface is configured to display an estimated time that the power source is able to simultaneously supply power to the plurality of auxiliary devices.

In some aspects, the techniques described herein relate to a method, including: displaying an estimated time that a power source of a motor vehicle is able to supply power to an auxiliary device, wherein the estimated time is displayed on a user interface of the motor vehicle.

In some aspects, the techniques described herein relate to a method, wherein the estimated time is based on an input providing information about the auxiliary device.

In some aspects, the techniques described herein relate to a method, wherein the information about the auxiliary device includes one or both of a power consumption rating of the auxiliary device and a type of the auxiliary device.

In some aspects, the techniques described herein relate to a method, wherein the power source is one or both of a traction battery pack and an internal combustion engine.

In some aspects, the techniques described herein relate to a method, wherein the user interface is provided by one or both of an infotainment system and a mobile device.

### BRIEF DESCRIPTION OF THE DRAWINGS

FIG. 1 schematically illustrates a motor vehicle.

FIG. 2 schematically illustrates aspects of an exemplary generator system of a motor vehicle.

FIG. 3 schematically illustrates aspects of another exemplary generator system of a motor vehicle.

FIG. 4 schematically illustrates an exemplary remote power supply system for a motor vehicle.

FIG. 5 schematically illustrates an exemplary method according to this disclosure.

### DETAILED DESCRIPTION

This disclosure relates generally to motor vehicles, and more particularly to vehicle systems and methods for estimating the runtime of one or more auxiliary devices that are powered by the motor vehicle. Among other benefits, which will be appreciated from the description below, this disclosure provides users with increased certainty regarding the duration that they are able to run one or more auxiliary devices using the power source(s) provided by the motor vehicle.

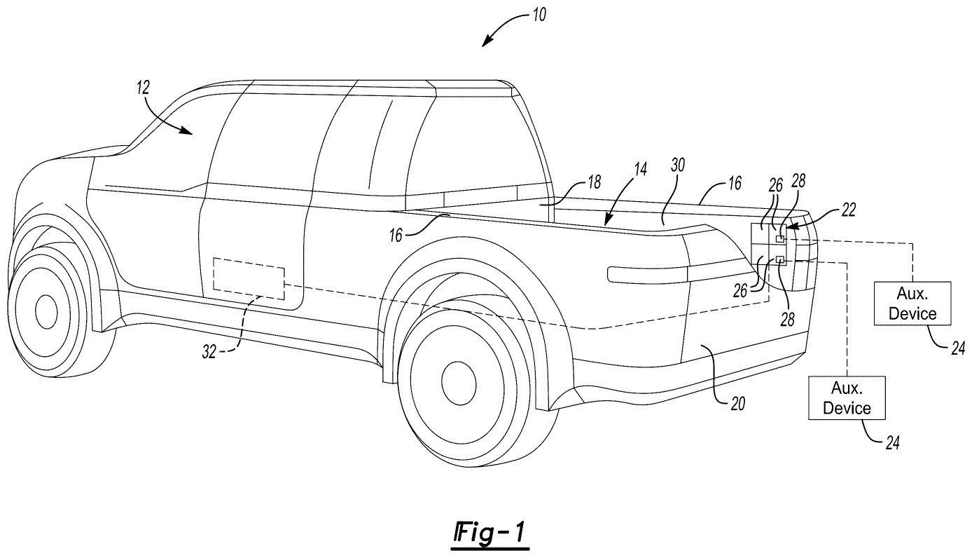

FIG. 1 schematically illustrates a motor vehicle 10 that includes a passenger cabin 12 and a cargo space 14 located rearward of the passenger cabin 12. The vehicle 10 could be an internal combustion engine powered vehicle, a hybrid electric vehicle (HEV), a plug-in hybrid electric vehicle (PHEV), a battery electric vehicle (BEV) without an internal combustion engine, an autonomous vehicle (i.e., a vehicle equipped with a self-driving system (SDS)), etc.

In an embodiment, the vehicle 10 is a pickup truck, and therefore the cargo space 14 is established by a cargo bed of the pickup truck. For example, the cargo space 14 may generally be defined by side walls 16, a front wall 18, and a tailgate 20 that acts as a rear wall of the cargo bed when closed. However, other vehicle configurations are also contemplated within the scope of this disclosure. For example, the vehicle 10 could be configured as a car, a truck, a van, a sport utility vehicle (SUV), etc.

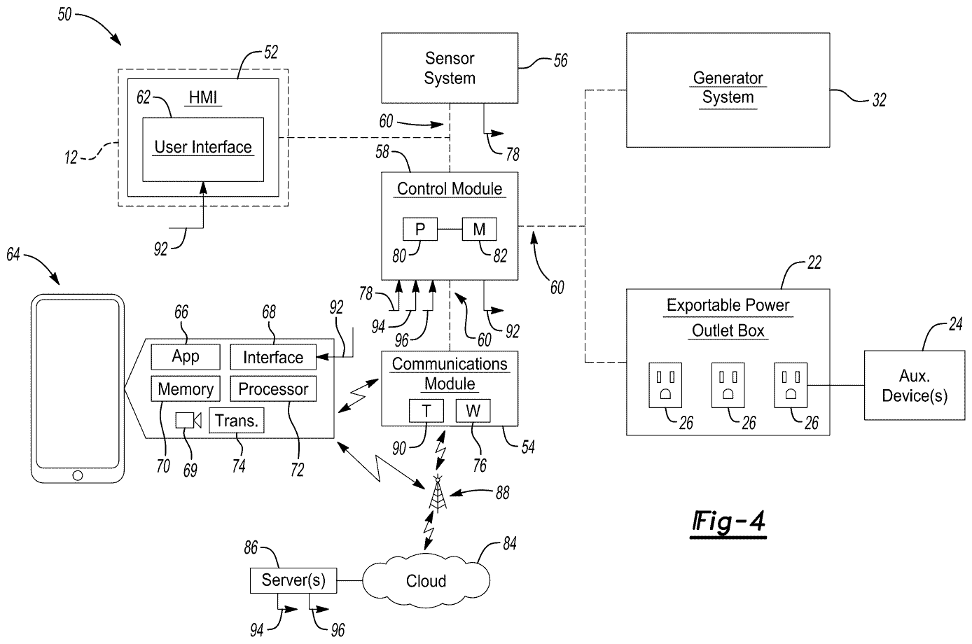

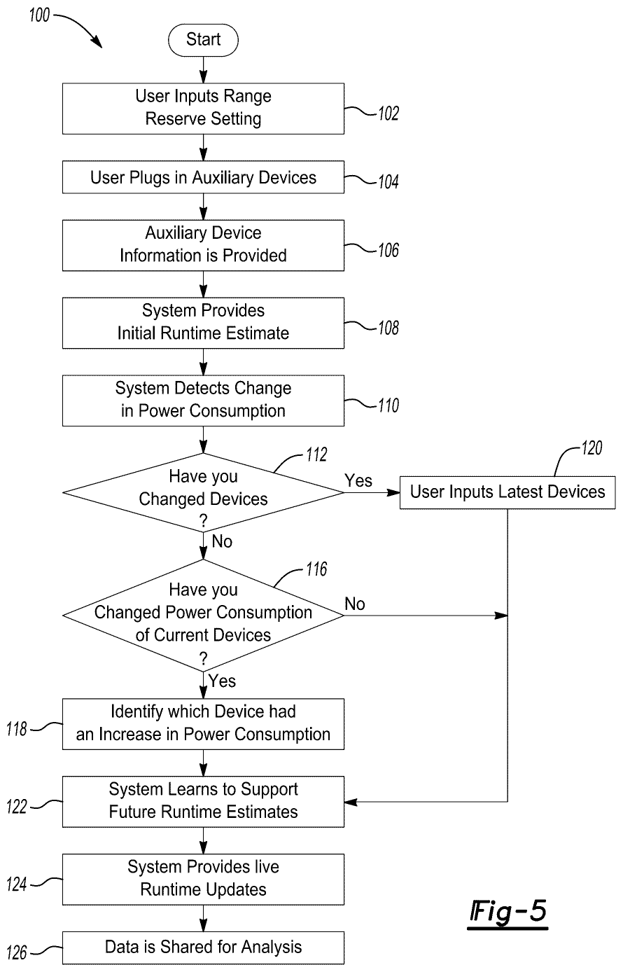

The vehicle 10 may include one or more exportable power outlet boxes 22. Each exportable power outlet box 22 may be part of a remote power supply system 50 (see FIG. 4) of the vehicle 10 that is configured for powering auxiliary devices 24 located external to/remote from the vehicle 10. The auxiliary devices 24 could be any electrically powered device, including but not limited to, power tools, recreational devices, campers or trailers, etc. Each exportable power outlet box 22 may include one or more electrical power outlets 26 that provide an interface for connecting the auxiliary devices 24. A user can couple a plug 28 of the auxiliary device 24 to one of the electrical power outlets 26 for powering the auxiliary device 24 using power originating from the vehicle 10. The electrical power outlets 26 may include 120V outlet ports, 240V outlet ports, USB ports, etc., or any combination of these or other power outlet ports.

Each exportable power outlet box 22 provided on the vehicle 10 may be mounted to a surface 30 of the vehicle 10. The surface 30 could be located anywhere on the vehicle 10, including any location within either the passenger cabin 12 or the cargo space 14. In an embodiment, the surface 30 is established by one of the side walls 16 of the cargo bed of the vehicle 10. However, other configurations are further contemplated within the scope of this disclosure.

Example locations for the exportable power outlet boxes 22 include, but are not limited to, a front trunk (“frunk”), cargo area, cargo bed, or a passenger cabin of the vehicle 10. The exportable power outlet box 22 could also be provided by a charging port of the vehicle 10. The vehicle 10 could include more than one exportable power outlet box 22, with multiple such boxes at different locations.

The vehicle 10 may further include a generator system 32, which may be part of a powertrain of the vehicle 10. The generator system 32 may be operably coupled to the exportable power outlet box 22 for supplying power to the electrical power outlets 26.

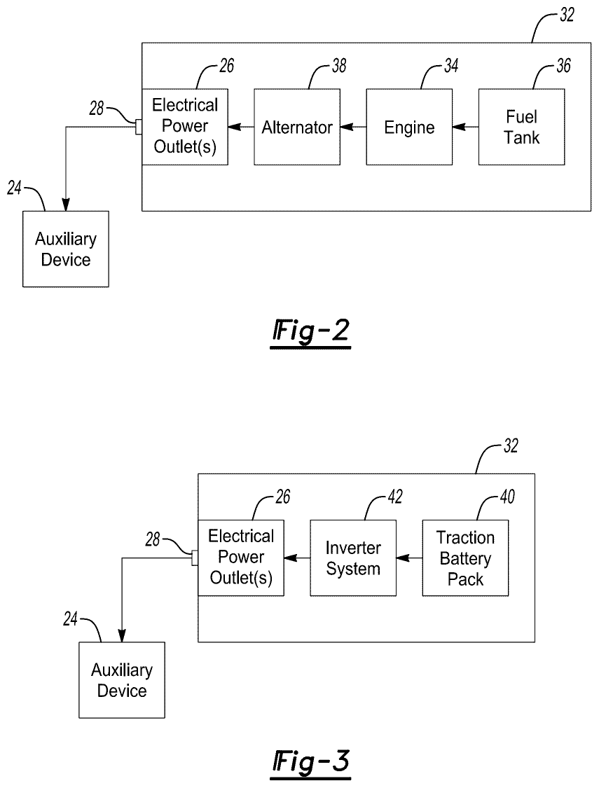

With reference to FIG. 2, in one example the generator system 32 includes an internal combustion engine 34, a fuel tank 36 for storing fuel (e.g., gasoline, diesel, etc.) that may be used to power the internal combustion engine 34, and an alternator 38. The alternator 38 may convert mechanical energy from the engine 34 into electrical energy that can be utilized to provide power to the electrical power outlets 26 of the exportable power outlet box 22 for powering the one or more auxiliary devices 24. In an embodiment, the alternator 38 is a 28 Volt alternator or battery, and operating the engine 34 can generate up to 10 Kilowatts of power through the alternator 38 that can be directed to the exportable power outlet box 22, such as when operating the vehicle 10 in a power generation mode, for example.

With reference to FIG. 3, in another example, the vehicle 10 is an electrified vehicle, such as an HEV, a PHEV, or a BEV. In this example, the generator system 32 includes a traction battery pack 40 and an inverter system 42. The traction battery pack 40 may be configured as a high voltage traction battery pack that includes a plurality of battery arrays (i.e., battery assemblies or groupings of battery cells) capable of outputting electrical power. The inverter system 42 may enable the transfer of power from the traction battery pack 40 to the exportable power outlet box 22 for supplying power to the electrical power outlets 26 at the correct voltage and current levels for supporting the auxiliary devices 24. The power from the traction battery pack 40 could be supplied to the exportable power outlet box 22 instead of or in addition to power supplied by an internal combustion engine.

FIG. 4 schematically illustrates a remote power supply system 50 that may be provided on the vehicle 10. The remote power supply system 50 may, for example, enable the vehicle 10 to operate in the power generation mode for powering one or more auxiliary devices 24 that are separate/remote from the vehicle 10. Moreover, as further explained below, the remote power supply system 50 may be further configured to control the vehicle 10 in a manner that provides a user with a runtime estimate, which is an estimated time that the remote power supply system 50 is able to supply power to one or more auxiliary devices.

The remote power supply system 50 may include the exportable power outlet box 22, the generator system 32, a human machine interface (HMI) 52, a communications module 54, a sensor system 56, and a control module, or controller, 58. These and various other components may be interconnected and in electronic communication with one another over one or more communication buses 60. The communication buses 60 may be wired communication buses such as a controller area network (CAN) bus, or wireless communication buses such as Wi-Fi, Bluetooth®, Ultra-Wide Band (UWB), etc.

The HMI 52 may be located within the passenger cabin 12 of the vehicle 10 and may include various user interfaces for displaying information to the vehicle occupants and for allowing the vehicle occupants to enter information into the HMI 52. The vehicle occupants may interact with the user interfaces via touch screens, tactile buttons, audible speech, speech synthesis, gesture recognition, etc. In an embodiment, the HM I 52 is part of an in-dash infotainment system of the vehicle 10. However, other configurations are further contemplated within the scope of this disclosure.

The HMI 52 may include one or more user interfaces 62 dedicated to functionality associated with the remote power supply system 50. The one or more user interfaces 62 may present power generation-related information to a user.

The vehicle user could alternatively or additionally interface with the remote power supply system 50 with a personal electronic device 64 (e.g., a smart phone, tablet, computer, wearable smart device, etc.). The personal electronic device 64, which may be referred to as a mobile device, in most implementations may belong to the owner/user of the vehicle 10. Regardless, when used as described in this disclosure, the personal electronic device 64 is deemed to be part of the remote power supply system 50 and/or the vehicle 10. The personal electronic device 64 may include an application 66 (e.g., FordPass™M or another similar application) that includes programming to allow the user to employ one or more user interfaces 68 for setting or controlling certain aspects of the remote power supply system 50. Power generation related information may be presented to the user within one or more of the user interfaces 68, such as when operating the vehicle 10 in power generation mode. The application 66 may be stored in a memory 70 of the personal electronic device 64 and may be executed by a processor 72 of the personal electronic device 64. The personal electronic device 64 may additionally include a transceiver 74 that is configured to communicate with the remote power supply system 50, such as via the communications module 54, for example.

In this disclosure, both the HMI 52 and the personal electronic device 64 are considered to provide user interfaces of the remote power supply system 50 and/or the vehicle 10. Specifically, both the interface 62 and interface 68 are considered user interfaces of the remote power supply system 50 and/or the vehicle 10. Both the HMI 52 and personal electronic device 64 are configured to permit a user to input information, input data, and/or make one or more selections to provide the control module 58 with information regarding the one or more auxiliary devices 24.

When the user interface is provided by user interface 62 of the infotainment system of the motor vehicle, for example, the information about the auxiliary device is discerned by the control module 58 based on a selection made by the user via the user interface 62 and/or data entered into the user interface 62. A user may provide the type, make, and/or model of the one or more auxiliary devices 24 from an a search interface or one or more drop-down menus, as examples.

When the user interface is provided by user interface 68 of the personal electronic device 64, the information about the auxiliary device 24 may be obtained using a camera 69 of the personal electronic device 64. The application 66 may interface with the camera 69 to obtain the information. In a specific implementation, the camera 69 may obtain an image of a computer-readable code, such as a barcode or a QR code, on or associated with the one or more auxiliary devices 24. Alternatively or additionally, the application 66 may permit a user to make a selection or input data to provide information about the one or more auxiliary devices 24. The information may be provided using a search interface, or one or more drop-down menus, as examples.

The communications module 54 may be configured for achieving bidirectional communications between the remote power supply system 50 and the personal electronic device 64. For example, the communications module 54 may include one or more wireless devices 76 that is operable to facilitate communications between the user and the remote power supply system 50. The wireless devices 76 may be embedded or otherwise mounted at various locations of the vehicle 10, such as within the front bumper, rack, molding, doors, in-vehicle components, etc. In an embodiment, the wireless devices 76 are Bluetooth® Low Energy (BLE) transceivers configured to receive and/or emit low energy signals as a way to detect and communicate with participating users. However, other types of wireless devices (e.g., WiFi, V2V, UWB, Cellular, etc.) are also contemplated within the scope of this disclosure.

The communications module 54 (and the personal electronic device 64) may be further configured to communicate over a cloud network 84 (i.e., the Internet) to obtain various information stored on one or more servers 86. Each server 86 can identify, collect, and store user data associated with the vehicle 10 for validation purposes and/or for purposes of evaluating historical runtime estimates, and specifically for purposes of refining and/or updating strategies for providing future runtime estimates. Upon an authorized request, data may be subsequently transmitted to the communications module 54, via a cellular tower 88 or some other known communication technique (e.g., Wi-Fi, Bluetooth®, etc.). The communications module 54 may include a transceiver 90 for achieving bidirectional communication with the cellular tower 88. For example, the transceiver 90 can receive data from the servers 86 or can communicate data back to the servers 86 via the cellular tower 88. Other components may enable bidirectional communications between the vehicle 10 and the web-based servers 86.

In an embodiment, the communications module 54 communicates with the servers 86 to obtain user history information 94 (e.g., location history, mode selection history, user settings history, etc.), historical runtime information 96 (e.g., previous runtime estimates corresponding to particular auxiliary devices that were provided to the user, and the corresponding actual runtimes experienced by the user), etc. The data received by the communications module 54 from the servers 86 may be communicated to the control module 58 where it can be used as a factor in determining a runtime estimate corresponding to a particular one or more of the auxiliary devices 24.

The sensor system 56 may include various sensors and other components (e.g., cameras, etc.) that are capable of monitoring the environment in and around the vehicle 10. For example, the sensor system 56 may include one or more of engine speed sensors, GPS sensors, forward, side, and rear-view cameras (such as part of a 360-degree camera system, for example), radar sensors, microphones, and/or various other sensors and components. The sensor system 56 may be configured to communicate sensor data 78 to the control module 58.

The control module 58 may include both hardware and software and could be part of an overall vehicle control system, such as a vehicle system controller (VSC), or could alternatively be a stand-alone controller separate from the VSC. In an embodiment, the control module 58 is programmed with executable instructions for interfacing with and commanding operation of various components of the remote power supply system 50. Although shown as separate modules in FIG. 4, the HMI 52, the communications module 54, and the control module 58 could be integrated together as part of common module of the vehicle 10.

The control module 58 may include a processor 80 and non-transitory memory 82 for executing various control strategies and modes associated with the remote power supply system 50. The processor 80 may be a custom made or a commercially available processor, a central processing unit (CPU), or generally any device for executing software instructions. The memory 82 can include any one or combination of volatile memory elements and/or nonvolatile memory elements. The processor 80 may be operably coupled to the memory 82 and may be configured to execute one or more programs stored in the memory 82 based on various inputs received from other devices associated with the remote power supply system 50.

The remote power supply system 50 is configured to provide a user with a runtime estimate corresponding to the one or more auxiliary devices 24. In particular, based on the present power capacity of the power source of the vehicle 10, which here is the generator system 32, including a level of fuel within the fuel tank 36 and/or a state of charge (SOC) of the traction battery pack 40, and based on information about the one or more auxiliary devices 24 that are, or are intended to be, coupled with the electrical power outlets 26, the remote power supply system 50 is configured to generate an estimated runtime that the generator system 32 is able to supply power to the one or more auxiliary devices 24. The remote power supply system 50 is further configured to cause a user interface, namely user interface 62 and/or user interface 68 of personal electronic device 64, to display the estimated runtime. The remote power supply system 50 may display the estimated runtime in the form of an alert 92, which may include one or more messages that can be displayed on the user interfaces 62, 68. The alert 92 may further include prompts notifying the user of a runtime estimate of the auxiliary device(s) 24. In this way, the user is provided with increased certainty regarding the duration that the generator system 32 is able to power the one or more auxiliary devices 24.

FIG. 5 schematically illustrates an exemplary method 100 according to this disclosure. The method 100 is configured to generate a runtime estimate corresponding to the auxiliary device(s) 24 and provide that runtime estimate to the user. The method 100 may include a greater or fewer number of steps than recited below, and the exact order of the steps is not intended to limit this disclosure.

The remote power supply system 50 may be configured to employ one or more algorithms adapted to execute the steps of the exemplary method 100. For example, the method 100 may be stored as executable instructions in the memory 82 of the control module 58, and the executable instructions may be embodied within any computer readable medium that can be executed by the processor 80 of the control module 58.

The exemplary method 100 begins with the vehicle 10 stationary. In other examples, the vehicle 10 may be moving. At 102, a user inputs a range reserve setting. The range reserve setting may be input by the user into one of the user interfaces 62, 68, and may indicate a minimum travel distance that the user desires to reserve for driving the vehicle 10. For example, if the user is at a worksite 40 miles from their home, the user may input a range reserve setting of 40 miles or higher, depending on a preference of the user. Alternatively, the range reserve setting may be determined by control module 58 automatically by comparing the current location of the vehicle 10 with a location of a home of the user. The range reserve setting may be a factory setting of the vehicle 10 in another example.

At 104, the user plugs one or more auxiliary devices 24 into the electrical power outlets 26. At 106, the user inputs information about the auxiliary device(s) into the interfaces 62, 68. In a particular example, step 106 comes before step 104. In another example, in response to the one or more auxiliary devices 24 being plugged in at 104, an alert 92 is pushed to the user indicating that one or more auxiliary devices 24 have been detected. The user is then prompted to input information about the auxiliary device(s) 24 via interfaces 62 or 68.

The information input at 106 includes a type, make, and/or model of the auxiliary device(s) 24. For example, if a user plugs in a power drill, the user may input or select “power drill” using interfaces 62 or 68. If the make and/or model of the auxiliary device 24 is known, the user may select or input that make and/or model. The information may also be provided by a user capturing an image of a computer-readable code on or associated with a particular auxiliary device 24 by using camera 69. Based on these selections/inputs, the control module 58 is able to determine one or more of a power consumption rating of the auxiliary device(s) 24, an operating voltage of the auxiliary device(s) 24, a duty cycle of the auxiliary device(s) 24, and/or a startup surge of the auxiliary device(s) 24. Such information may be set by a manufacturer of a particular auxiliary device 24 and known to the control module 58. For example, the control module 58 may have access to a bank of known auxiliary devices and their corresponding manufacturer-set ratings and/or specifications, and that bank may be stored in memory 82. Alternatively or additionally, the control module 58 is capable of obtaining the specifications of a particular auxiliary device 24 using the Internet.

In an alternative embodiment, the control module 58 can discern information about the auxiliary device(s) 24 automatically when the auxiliary device(s) 24 are plugged into the vehicle 10. In that example, the auxiliary device(s) may include a power cable and plug that is able to establish both a power connection and data connection with the vehicle 10. The data connection allows the control module 58 to discern information about the auxiliary device(s) 24, including relevant specifications such as power consumption, operating voltage, etc.

At 108, the control module 58 determines an initial runtime estimate and presents the initial runtime estimate to the user in the form of an alert 92 pushed to the interface 62 and/or 68. The initial runtime estimate is a time in the form of hours, minutes, and/or seconds, for example. The initial runtime estimate may be displayed using a graphic presented on the interfaces 62 and/or 68, in other examples.

The initial runtime estimate is determined based on one or more factors, including the information discerned based on the inputs provided at 106, information corresponding to the capacity of the generator system 32, such as a fuel level of the fuel tank 36 and/or a state of charge of the traction battery pack 40, and/or a range reserve setting. In general, the control module 58 estimates runtime by comparing the total capacity of the generator system, less a capacity needed to meet the range reserve setting, with an estimated power consumption of the auxiliary device(s) 24.

The method 100 continues, monitoring actual power consumption of the auxiliary device(s) 24 as they are used. If, during use, the actual power consumption of the auxiliary device(s) 24 varies significantly from what was initially estimated, the control module 58 may determine that an update to the initial runtime estimate should be provided to the user. If this occurs at 110, a prompt may be delivered to the user, inquiring whether the user has changed the quantity and/or type of auxiliary device(s) 24 that are plugged into the electrical power outlets 26, at 112. The user is able to answer the prompt via interface 62 or 68.

If the user answers “no” at 112, then at 114 another prompt is delivered to the user inquiring whether the user has changed a power consumption of one or more of the auxiliary devices 116. If “yes” at 116, then at 118 the user provides corresponding information via the interface 62 and/or 68. An example, the auxiliary device 24 may be an electric space heater, and the user may have changed a setting from low to medium, or medium to high, as examples, such that the auxiliary device 24 is consuming a different level of power than initially expected. The user can indicate the change in power level via interface 62 or 68.

If the user answers “yes” at 112, then at 120 the user inputs information corresponding to the recently-changed auxiliary device(s) 24 so that the control module 58 is apprised of information, including relevant specifications, corresponding to the auxiliary device(s) 24 that are presently plugged into electrical power outlets 26.

In an aspect of the method 100, if the user does not respond to the alerts at 106 or there is otherwise no information about the auxiliary device(s) 24, a runtime estimate is generated, at 108, based on a detected power consumption occurring via the unknown auxiliary device(s) coupled to the electrical power outlets 26. In this regard, step 110 may precede step 108.

At 122, the remote power supply system 50, and in particular the control module 58, is configured to compare the initial runtime estimate provided at 108 to real-time conditions, and in particular is able to determine how closely the initial runtime estimate is reflecting the real-time runtime of the auxiliary device(s) 24. Further, following use of the auxiliary device(s) 24 the remote power supply system 50 is configured to determine how closely the initial runtime estimate provided at 108, and any runtime updates provided to the user during use of the auxiliary devices 24, reflected actual runtime of the auxiliary device(s) 24. The remote power supply system 50 may update one or more of lookup tables and/or algorithms of the control module 58 to provide more accurate future runtime estimates. Such information may be shared, at 126, to server(s) 86 for further analysis and/or for determining whether system updates should be provided to other vehicles configured with the functionality of vehicle 10. Such information may be used during future uses of the method 100, at steps 108 and 124.

At 124, if necessary, the control module 58 is configured to update the runtime estimate provided at 108 via pushing a message, for example, to interfaces 62 and/or 68. The updated runtime estimate may be based on ambient conditions, such as weather conditions, relative to the vehicle 10. For example, if the initial runtime estimate was made during warm weather conditions, but the weather turns substantially cooler, the runtime estimate may be shortened at 124.

In a further aspect of the method 100, at 106 the user could select one of a plurality of pre-set profiles, each corresponds to a set of particular auxiliary devices 24. One example profile is a “tailgating” profile. The control module 58 may save the profile in memory 82. An example “tailgating” profile, may include the auxiliary devices of a microwave, light, and television. The user may save the particular type, make, and model of each auxiliary device 24 in the profile. In this way, the user does not need to manually enter the same auxiliary devices 24 each time the user engages in a particular activity, such as tailgating.

It should be understood that terms such as “about,” “substantially,” and “generally” are not intended to be boundaryless terms, and should be interpreted consistent with the way one skilled in the art would interpret those terms. It should also be understood that directional terms are used herein relative to the normal operational attitude of a vehicle for purposes of explanation only, and should not be deemed limiting.

Although the different examples have the specific components shown in the illustrations, embodiments of this disclosure are not limited to those particular combinations. It is possible to use some of the components or features from one of the examples in combination with features or components from another one of the examples. In addition, the various figures accompanying this disclosure are not necessarily to scale, and some features may be exaggerated or minimized to show certain details of a particular component or arrangement.

One of ordinary skill in this art would understand that the above-described embodiments are exemplary and non-limiting. That is, modifications of this disclosure would come within the scope of the claims. Accordingly, the following claims should be studied to determine their true scope and content.

1. A motor vehicle, comprising:
a power source;
a user interface configured to display an estimated time that the power source is able to supply power to an auxiliary device; and
a controller configured to generate the estimated time based on a selection or entry, made by a user via the user interface, of a type, make, or model of the auxiliary device, and to cause the user interface to display the estimated time.

2. (canceled)

3. The motor vehicle as recited in claim 1, wherein, after the controller first causes the user interface to display the estimated time, the controller is configured to cause the user interface to display an updated estimated time that the power source is able to supply power to the auxiliary device.

4. (canceled)

5. The motor vehicle as recited in claim 1, wherein the controller generates the estimated time based on a power capacity of the power source.

6. The motor vehicle as recited in claim 5, wherein the power source includes a traction battery pack, and the power capacity is a state of charge of the traction battery pack.

7. The motor vehicle as recited in claim 5, wherein the power source includes an internal combustion engine, and the power capacity is a fuel level.

8. The motor vehicle as recited in claim 5, wherein the controller generates the estimated time based on a range reserve setting.

9. The motor vehicle as recited in claim 1, wherein the selection or entry is discerned from a machine-readable code associated with the auxiliary device.

10. The motor vehicle as recited in claim 9, wherein the machine-readable code is one of a QR code or a barcode.

11. The motor vehicle as recited in claim 1, wherein the selection or entry includes one or both of a power consumption rating of the auxiliary device and a type of the auxiliary device.

12. The motor vehicle as recited in claim 1, wherein:
the user interface is provided by an infotainment system of the motor vehicle.

13. The motor vehicle as recited in claim 1, wherein:
the user interface is provided by a mobile device, and
the selection or entry is obtained using a camera of the mobile device.

14. The motor vehicle as recited in claim 1, further comprising:
an electrical outlet configured to receive a plug of the auxiliary device and to direct power from the power source to the auxiliary device,
wherein the motor vehicle is a pickup truck, and
wherein the electrical outlet is arranged adjacent a cargo area of the pickup truck.

15. The motor vehicle as recited in claim 1, wherein the auxiliary device is one of a plurality of auxiliary devices, and wherein the user interface is configured to display an estimated time that the power source is able to simultaneously supply power to the plurality of auxiliary devices.

16. A method, comprising:
displaying an estimated time that a power source of a motor vehicle is able to supply power to an auxiliary device, wherein the estimated time is displayed on a user interface of the motor vehicle, wherein the estimated time is based on an input providing information about the auxiliary device, and wherein the information about the auxiliary device is discerned from a machine-readable code associated with the auxiliary device.

17. (canceled)

18. The method as recited in claim 16, wherein the information about the auxiliary device includes one or both of a power consumption rating of the auxiliary device and a type of the auxiliary device.

19. The method as recited in claim 16, wherein the power source is one or both of a traction battery pack and an internal combustion engine.

20. The method as recited in claim 16, wherein the user interface is provided by one or both of an infotainment system and a mobile device.

21. The motor vehicle as recited in claim 1, wherein the selection or entry is a selection of a pre-set profile corresponding to a set of auxiliary devices that includes the auxiliary device.

22. The motor vehicle as recited in claim 3, wherein the updated estimated time is based on an ambient condition relative to the motor vehicle.

23. A system for a motor vehicle, comprising:
a power source configured to supply power to an auxiliary device;
a user interface; and
a controller configured to generate an estimated time that the power source is able to supply power to the auxiliary device, the estimated time being based on an estimated power consumption of the auxiliary device, to cause the user interface to display the estimated time, to monitor an actual power consumption of the auxiliary device, and, in response to the actual power consumption varying from the estimated power consumption, to cause the user interface to display a prompt for updated information about the auxiliary device and to generate an updated estimated time based on a response to the prompt.
